(19) United States
(12) Patent Application Publication
(10) Pub. No.: US 2020/0198911 A1
(43) Pub. Date: Jun. 25, 2020

(54) IMAGE FORMING DEVICE, CONTROLLING METHOD AND NON-TRANSITORY RECORDING MEDIUM

(71) Applicant: KONICA MINOLTA, INC., Tokyo (JP)

(72) Inventor: Yasuji WATANABE, Toyokawa-shi (JP)

(21) Appl. No.: 16/725,178

(22) Filed: Dec. 23, 2019

(30) Foreign Application Priority Data
Dec. 25, 2018 (JP) 2018-240905

(51) Int. Cl. B65H 7/08; G03G 15/00; B65H 5/06

(52) U.S. Cl. CPC B65H 7/08; B65H 5/06; G03G 15/6567

(57) ABSTRACT

An image forming device comprising: a feeder that feeds a sheet; a resisting unit that corrects skew of the sheet fed by the feeder and carries the sheet toward downstream side; a detector that detects the sheet carried toward downstream side by the resisting unit after the skew of the sheet is corrected; and a hardware processor that drives the feeder and the resisting unit, respectively. The hardware processor starts driving the resisting unit before the sheet fed by the feeder reaches the resisting unit.

### CROSS-REFERENCE TO RELATED APPLICATION

The present invention claims priority under 35 U.S.C. § 119 to Japanese patent application No. 2018-240905 filed on Dec. 25, 2018, the entire contents of which are incorporated herein by reference.

### BACKGROUND

### Technological Field

The present invention relates to an image forming device, a controlling method and a non-transitory recording medium.

### Description of the Related Art

Conventional image forming devices include resisting parts that correct skew of a sheet. The resisting part includes a pair of resist rollers. The resisting part presses a leading end of the sheet against a nip part of the pair of resist rollers and a loop is formed on the sheet. The skew of the sheet is generally thereby corrected.

As a structure of the resisting part of the conventional image forming device, the one corrects the skew of the sheet just before the sheet is carried to a pair of timing rollers is known. This known technique is introduced for example in Japanese Patent Application Laid-Open No. JP 2017-88320 A. According to the known technique, a shutter member provided with a swivel support point in upstream side of the pair of timing rollers corrects the skew of the sheet. To be more specific, while the shutter member is in a standby state, a tip of the shutter member is inclined so as to cross a carrying path of the sheet. In this state, the sheet is not guided to the nip part of the pair of timing rollers. The shutter member in the standby state enables the leading end of the sheet carried from upstream side to be in contact with a surface of one of the pair of timing rollers to correct the skew of the sheet. After the correction of the skew of the sheet, the shutter member opens an entry to the nip part of the pair of timing rollers by swiveling based on the swivel support point due to a tensility of the sheet, and delivers the sheet to the nip part.

Once the leading end of the sheet is delivered to the nip part of the pair of timing rollers (including resist rollers), the conventional image forming device temporarily stops a carrying operation of the sheet. The driving of the pair of timing rollers is started at a timing that an image formed at an image forming unit reaches a predetermined image transfer position. The sheet is then supplied to the image transfer position. In order to perform the aforementioned operation, the conventional image forming device is provided with a sheet detecting sensor more upstream of the resisting part. As a result of the detection of the arrival of the leading end of the sheet by the sheet detecting sensor, the carrying operation of the sheet is temporarily stopped. Hence, when the pair of timing rollers are started driving, the leading end of the sheet is always at the same position. The leading end of the sheet may be delivered to the image transfer position at a predetermined timing corresponding to the timing that the image formed at the image forming unit reaches the image transfer position.

In view of further reduction in costs and saving spaces, it has recently been considered to include integrally a skew correction member with the similar function as the aforementioned shutter member and the timing roller. By integrally including the sheet detecting sensor with the timing roller and/or the skew correction member, a further compact structure may be realized. By realizing such structure, the sheet detecting sensor may be arranged to detect that the sheet is carried to a predetermined position in downstream side of the timing roller. More specifically, the sheet detecting sensor does not detect the sheet when the leading end of the sheet reaches the nip part of the pair of timing rollers. The sheet detecting sensor detects the sheet when the sheet is fed further downstream side of the timing roller.

When applying the known technique to the structure having the sheet detecting sensor detects the sheet in downstream side of the timing roller, the timing roller has not been driven at the time that the leading end of the sheet reaches the nip part of the pair of timing rollers. The leading end of the sheet cannot be delivered to the detecting position by the sheet detecting sensor in further downstream side. In this case, the detection of the sheet reaching may not be normally performed.

### SUMMARY

The present invention is intended to solve the above problems. Thus, the present invention is intended to provide an image forming device, a controlling method and a non-transitory recording medium that enables a detector that detects a sheet to normally perform detection of a sheet arrival even with a structure with the detector that detects the sheet carried further downstream side from a resisting part.

First, the present invention is directed to an image forming device.

To achieve at least one of the abovementioned objects, according to an aspect of the present invention, the image forming device reflecting one aspect of the present invention comprises: a feeder that feeds a sheet; a resisting unit that corrects skew of the sheet fed by the feeder and carries the sheet toward downstream side; a detector that detects the sheet carried toward downstream side by the resisting unit after the skew of the sheet is corrected; and a hardware processor that drives the feeder and the resisting unit, respectively. The hardware processor starts driving the resisting unit before the sheet fed by the feeder reaches the resisting unit.

Second, the present invention is directed to a controlling method. The controlling method is applied at an image forming device comprising: a feeder that feeds a sheet; a resisting unit that corrects skew of the sheet fed by the feeder and carries the sheet toward downstream side; and a detector that detects the sheet carried toward downstream side by the resisting unit after the skew of the sheet is corrected.

To achieve at least one of the abovementioned objects, according to an aspect of the present invention, the controlling method reflecting one aspect of the present invention comprises: driving the feeder and starting feeding the sheet; and starting driving the resisting unit before the sheet fed out by the feeder reaching the resisting unit.

Third, the present invention is directed to a non-transitory recording medium storing a computer readable program to be executed by a hardware processor in an image forming device comprising: a feeder that feeds a sheet; a resisting unit that corrects skew of the sheet fed by the feeder and carries the sheet toward downstream side; and a detector that detects the sheet carried toward downstream side by the resisting unit after the skew of the sheet is corrected.

To achieve at least one of the abovementioned objects, according to an aspect of the present invention, the non-transitory recording medium storing a computer readable program to be executed by the hardware processor in the image forming device reflecting one aspect of the present invention causing the hardware processor to perform: driving the feeder and starting feeding the sheet; and starting driving the resisting unit before the sheet fed out by the feeder reaching the resisting unit.

### BRIEF DESCRIPTION OF THE DRAWING

The advantages and features provided by one or more embodiments of the invention will become more fully understood from the detailed description given herein below and the appended drawings which are given by way of illustration only, and thus are not intended as a definition of the limits of the present invention.

FIG. 1 illustrates an exemplary structure of an image forming device;

FIG. 2 illustrates an exemplary structure of a resisting unit;

FIG. 3 is a plan view explaining a concept of a skew correction of a sheet;

FIG. 4 is a plan view explaining a concept of the skew correction of the sheet;

FIG. 5 illustrates gate members in a second posture;

FIG. 6A, FIG. 6B and FIG. 6C illustrate side views of the gate member changing posture;

FIG. 7 illustrates a block diagram showing an example of a hardware structure and a functional structure of a controller;

FIG. 8 illustrates a flow diagram explaining an exemplary procedure of a resisting controlling process;

FIG. 9 illustrates an exemplary timing of driving a paper feeding unit and the resisting unit;

FIG. 10 illustrates a flow diagram explaining another exemplary procedure of the resisting controlling process;

FIG. 11 illustrates another exemplary timing of driving the paper feeding unit and the resisting unit; and

FIG. 12 illustrates an example of modification relating to a position of a sensor.

### DETAILED DESCRIPTION OF EMBODIMENTS

Hereinafter, one or more embodiments of the present invention will be described with reference to the drawings. However, the scope of the invention is not limited to the disclosed embodiments.

### First Preferred Embodiment

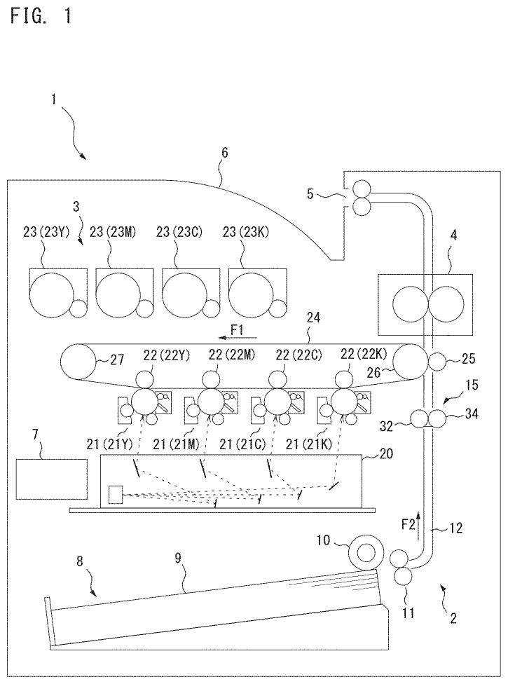

FIG. 1 illustrates an exemplary structure of an image forming device 1 in which the present preferred embodiment of the present invention may be practiced. The image forming device 1 of FIG. 1 is a printer capable of forming images on a sheet 9 such as a printing sheet in electrophotography and forming color images in tandem system. The image forming device 1 includes a feeding unit 2, an image forming unit 3 and a fixing unit 4 inside a device body. The image forming device 1 carries the sheet 9 stored in a paper feeding cassette 8 arranged in a lower part one after the other and forms a color image or a black and white image on the sheet 9. The image forming device 1 then delivers the sheet 9 on a paper delivery tray 6 from a paper delivery port 5 provided in an upper part. The image forming device 1 includes a controller 7 inside the device body. The controller 7 controls operations of each part such as the feeding unit 2, the image forming unit 3 and the fixing unit 4.

The feeding unit 2 includes the paper feeding cassette 8, a pick-up roller 10, a feeder 11, a carrying path 12, a resisting unit 15 and a secondary transfer roller 25. The paper feeding cassette 8 is a container in which a bundle of the sheets 9 are stored. The pick-up roller 10 takes the single sheet 9 from a top of the bundle of the sheets 9 stored in the paper feeding cassette 8, and feeds out toward the feeder 11. The pick-up roller 10 sometimes feeds out more than one sheets 9 toward downstream of the paper feeding cassette 8. The feeder 11 only takes the single sheet 9 on top of the single or more than one sheets 9 fed out by the pick-up roller 10 and supplies the single sheet 9 to the downstream carrying path 12.

The carrying path 12 is a path to carry the sheet 9 in an arrow F2 direction. The resisting unit 15 corrects the skew of the sheet 9 carried along the carrying path 12. The resisting unit 15 includes a pair of timing rollers 32 and 34. The resisting unit 15 corrects the skew of the sheet 9 at the upstream side from the pair of timing rollers 32 and 34. The resisting roller 15 then holds the leading end of the sheet 9 with a nip part of the pair of timing rollers 32 and 34. When the leading end of the sheet 9 is hold with the nip part of the pair of timing rollers 32 and 34, the feeding unit 2 temporarily stops carrying the sheet 9. The resisting unit 15 drives the pair of timing rollers 32 and 34 in accordance with a timing that a toner image formed by the image forming unit 3 moves to a position of the secondary transfer roller 25, and carries the sheet 9 to the position of the secondary transfer roller 25. The toner image is transferred to the sheet 9 when the sheet 9 passes through the nip position of the secondary transfer roller 25. The toner image transferred on a surface of the sheet is then fixed to the sheet 9 when the sheet 9 passes through the fixing unit 4. The fixing unit 4 performs a heating operation and a pressure operation on the carried sheet 9 so that the toner image is fixed to the sheet 9. The sheet 9 is then delivered on the paper delivery tray 6 from the delivery port 5.

The image forming unit 3 forms toner images of four colors, Y (yellow), M (magenta), C (cyan) and K (black), and transfers the toner images of the four colors at the same time to the sheet 9 passing through the position of the secondary transfer roller 25. The image forming unit 3 includes an exposure unit 20, image forming units 21 (21Y, 21M, 21C and 21K), primary transfer rollers 22 (22Y, 22M, 22C and 22K), an intermediate transfer belt 24 and toner bottles 23 (23Y, 23M, 23C and 23K) of the respective colors. The image forming units 21 (21Y, 21M, 21C and 21K) are provided for the toners of respective colors. The primary transfer rollers 22 (22Y, 22M, 22C and 22K) are provided corresponding to the respective image forming units 21. Four image forming units 21Y, 21M, 21C and 21K, for example, are provided in a lower position of the intermediate transfer belt 24. The exposure unit 20 is arranged in a further lower position of the four image forming units 21Y, 21M, 21C and 21K. Each of the toner bottles 23Y, 23M, 23C and 23K supplies the toner of each color to the corresponding image forming unit 21Y, 21M, 21C or 21K.

The exposure unit 20 exposes an image carrier (photoreceptor drum) provided with each image forming unit 21Y, 21M, 21C and 21K and forms a latent image on the surface of the image carrier of each image forming unit 21Y, 21M, 21C and 21K. Each image forming unit 21Y, 21M, 21C and 21K develops the latent image with the toner so that the toner image is formed on a surface of the image carrier. Each image forming unit 21Y, 21M, 21C and 21K then superposes the toner image of each color one after another on the intermediate belt 24 which is circulated and moved in an arrow direction F1 to enable primary transfer by working together with the respective primary transfer rollers 22Y, 22M, 22C and 22K. When the intermediate transfer belt 24 passes through the position of the image forming unit 21K which is at downstream end, a color image which is superposing the toner images of four colors is formed on the surface of the intermediate transfer belt 24. The toner image formed on the intermediate transfer belt 24 is in contact with the sheet 9 carried by the feeding unit 2 and secondarily transferred on the surface of the sheet 9 when passing through a position faces the secondary transfer roller 25.

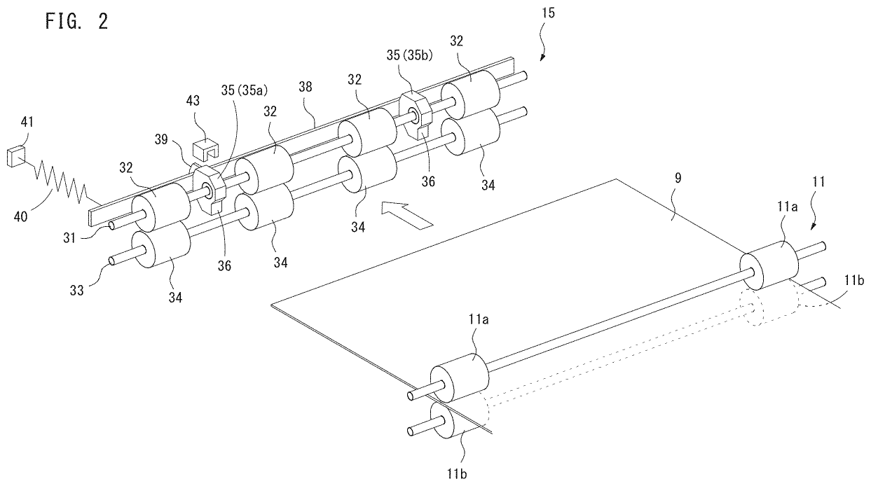

A structure of the resisting unit 15 is explained next. FIG. 2 illustrates an exemplary structure of the resisting unit 15. The feeder 11 includes multiple paper feeding rollers 11a and 11b facing each other via the carrying path 12. The feeder 11, for example, holds two positions of the sheet 9 and feeds out the sheet 9 in a direction illustrated by an arrow of FIG. 2. The feeder 11 is arranged at upstream side from the resisting unit 15 on the carrying path 12 of the sheet 9. The feeder 11 carries the sheet 9 fed by the paper feeding rollers 11a and 11b toward the resisting unit 15. Another carrying roller may be further arranged between the feeder 11 and the resisting unit 15.

The resisting unit 15 is arranged at a predetermined position which is at upstream side from the secondary transfer roller 25 on the carrying path 12. The resisting unit 15 includes multiple timing rollers 32 and 34 facing each other via the carrying path 12. The multiple timing rollers 32 and 34 make a pair of each other. The timing roller 32 is attached to a rotation shaft 31 which is driven by a motor not shown in FIG. 2. When the rotation shaft 31 is rotated and driven in a predetermined direction, the timing roller 32 rotates in response to the rotation of the rotation shaft 31. The timing rollers 32 are arranged in multiple positions (four positions in the present preferred embodiment) at specific intervals along a shaft direction of the rotation shaft 31. The timing roller 34 is attached to a rotation shaft 33, and is rotated in a predetermined direction together with the rotation shaft 33. The timing rollers 34 are also arranged in multiple positions (four positions in the present preferred embodiment) at specific intervals along a shaft direction of the rotation shaft 33. The timing rollers 34 are arranged at the same positions as the timing rollers 32 in the shaft direction. The resisting unit 15 holds the sheet 9 in the nip part of a pair of the timing rollers 32 and 34 and rotates the timing rollers 32 and 34 so that it may carry the sheet 9 toward further downstream side.

Moreover, gate members 35a and 35b are provided with two positions of the rotation shaft 31 of the resisting unit 15 to which the timing roller 32 is attached. The gate members 35a and 35b are freely rotatably attached. Hence, even when the rotation shaft 31 and the timing roller 32 are rotated and driven in the predetermined direction, the gate members 35a and 35b do not rotate together with the rotation shaft 31 and the timing roller 32. The gate members 35a and 35b are rotatable and displaceable around the rotation shaft 31 separately from the rotation shaft 31 and the timing roller 32. The two gate members 35a and 35b are integrally connected by a connection bar 38 which is arranged at a position that does not interfere the timing roller 32. The two gate members 35a and 35b integrally rotate around the rotation shaft 31. The gate members 35a and 35b are symmetrically arranged on both sides via a center part in longitudinal direction of the rotation shaft 31, for instance. The gate members 35a and 35b correct the skew of the sheet 9. To be more specific, the gate members 35a and 35b are a skew correction member provided with the resisting unit 15. When it is not necessary to distinct the two gate members 35a and 35b, they are referred as just a gate member 35.

Each gate member 35a and 35b includes a sheet locking unit 36 that is in contact with the leading end of the sheet 9 and locks the leading end of the sheet 9. Each gate member 35a and 35b is arranged oscillatably to change posture between a first posture and a second posture. The first posture enables the sheet locking unit 36 to be arranged at a predetermined position in upstream side of the nip part of the timing rollers 32 and 34 to lock the leading end of the sheet 9. The second posture enables the sheet locking unit 36 to retract to downstream side from the nip part of the timing rollers 32 and 34 to allow the sheet 9 to pass through. The gate members 35a and 35b in the first posture correct the skew of the sheet 9 before the sheet 9 is led to the nip part of the gate members 35a and 35b. After the skew of the sheet 9 is corrected, the gate members 35a and 35b change the postures from the first posture to the second posture and lead the sheet 9 to the nip part of the timing rollers 32 and 34.

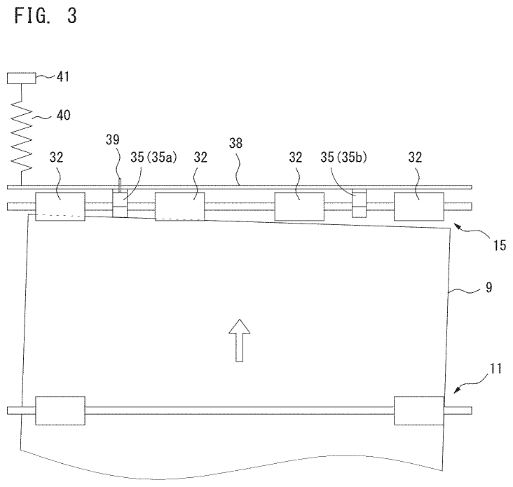

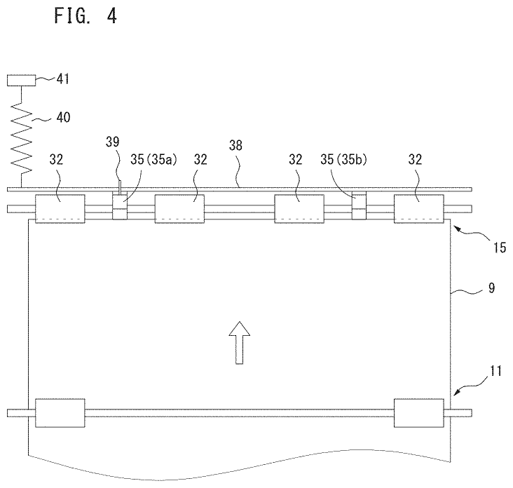

FIG. 3 and FIG. 4 are plan views explaining a concept of the skew correction of the sheet 9. When the sheet 9 is obliquely carried from the feeder 11 as illustrated in FIG. 3, the leading end of the sheet 9 is in contact with the sheet locking unit 36 of the gate member 35a of the two gate members 35a and 35b. When the leading end of the sheet 9 is only in contact with the gate member 35a which is one of the two gate members 35a and 35b, the sheet 9 cannot push the sheet locking unit 36 in so that the leading end of the sheet 9 locked by the sheet locking unit 36 remains at the position.

The sheet feeding operation by the feeder 11 continues even after that, and the following part of the sheet 9 proceeds to the feeding direction. The leading end of the sheet 9 then gets in contact with the sheet locking unit 36 of the gate member 35b which is another one of the two gate members 35a and 35b. As described above, once the leading end of the sheet 9 is locked by both of the sheet locking units 36 of the two gate members 35a and 35b, the correction of the skew of the sheet 9 completes. The leading end of the sheet 9 is in contact with both of the sheet locking units 36 of the two gate members 35a and 35b. The feeding force by the feeder 11 and pressing force due to the strength of tensility of the sheet 9 uniformly apply to the two sheet locking units 36. The sheet 9 is then enabled to push the sheet locking units 36 to downstream side. The sheet locking units 36 are pushed to downstream side so that the gate members 35a and 35b rotate around the rotation shaft 31 and change the postures from the first posture to the second posture.

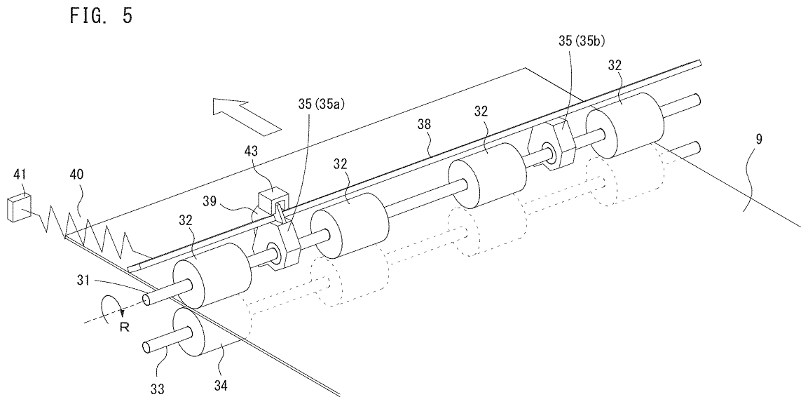

FIG. 5 illustrates the gate members 35a and 35b in the second posture. Once pushing the sheet locking units 36 of the two gate members 35a and 35b and moving toward downstream side, the leading end of the sheet 9 reaches the nip part between the pair of timing rollers 32 and 34. The resisting unit 15 rotates and drives in advance the rotation shaft 31 in R direction and waits in a manner the timing roller 32 rotating in the R direction. At the time the leading end of the sheet 9 reaches the nip part between the pair of timing rollers 32 and 34, the timing roller 32 has already been started driving. Thus, the sheet 9 is hold by the nip part between the pair of timing rollers 32 and 34, and the leading end of the sheet 9 is carried further toward downstream side in the feeding direction due to the feeding force applied by the timing rollers 32 and 34. This enables the two gate members 35a and 35b to change the postures to the second posture. The gate members 35a and 35b in the second posture enable the sheet locking unit 36 to retract to an upper position in downstream side of the carrying path. The sheet 9 is then allowed to pass toward downstream. To be more specific, while the sheet 9 is passing through the resisting unit 15, the gate members 35a and 35b maintain their postures in the second posture.

The resisting unit 15 includes an urging member 40 to put the gate members 35a and 35b back in the original first posture after a rear end of the sheet 9 passes through the gate members 35a and 35b. The urging member 40, for instance, is formed of a coil spring. One end of the urging member 40 is connected to a fixing part 41 inside the device body and another end is connected to the connection bar 38. The urging member 40 always applies an urging force to enable the gate members 35a and 35b to keep the first posture. Once the gate members 35a and 35b oscillate and change the postures to the second posture, the urging member 40 applies larger urging force to the gate members 35a and 35b to put the gate members 35a and 35b back to the first posture. After the rear end of the sheet 9 passes through the gate members 35a and 35b, the urging member 40 puts the gate members 35a and 35b back to the original first position due to the urging force.

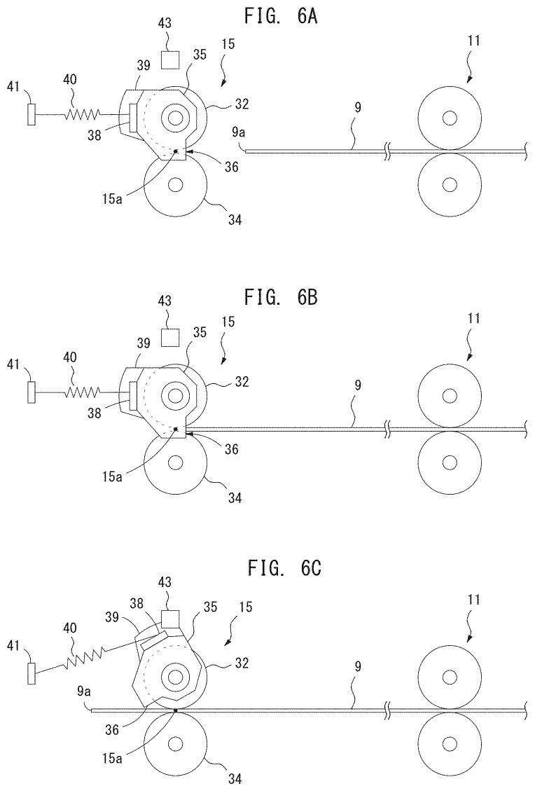

FIG. 6A, FIG. 6B and FIG. 6C illustrate side views of the gate member 35 changing posture. FIG. 6A illustrates the gate member 35 in the first posture. While the gate member 35 is in the first posture, the sheet locking unit 36 is placed at a predetermined position in upstream side from the nip part 15a between the timing rollers 32 and 34. While the gate member 35 is in the first posture, the sheet 9 is carried to the resisting unit 15 by the feeder 11. A leading end 9a of the sheet 9 engages with the two sheet locking units 36 as illustrated in FIG. 6A so that the skew of the sheet 9 is corrected. The gate member 35 maintains the first posture until the skew correction completes. The leading end 9a of the sheet 9 are in contact with the two sheet locking units 36 and the skew of the sheet 9 is corrected. The sheet 9 then rotates the gate member 35. The timing rollers 32 and 34 which have already been driven clamp the leading end of the sheet 9 and carry the sheet 9 toward downstream. The gate member 35 then changes the posture to the second posture as illustrated in FIG. 6C. Once the gate member 35 changes posture to the second posture, the sheet locking unit 36 moves to the downstream side from the nip part 15a between the timing rollers 32 and 34 and enables the sheet 9 to pass through. The gate member 35 maintains the second posture until the rear end of the sheet 9 passes through. After the rear end of the sheet 9 passes through the gate member 35, the gate member 35 is back to the first posture as illustrated in FIG. 6 due to the urging force applied by the urging member 40.

The resisting unit 15 is provided with a sensor 43 that detects the posture of the gate member 35. The sensor 43 is arranged near the gate member 35. As illustrated in FIG. 6, for example, the sensor 43 is placed at upper position of the gate member 35a. The sensor 43 is arranged separately from the connection bar 38 and/or the gate member 35, and is fixed to inside the device. Hence, even when the gate member 35 and/or the connection bar 38 is displaced, the position of the sensor 43 does not change.

The sensor 43 detects change in posture of the gate member 35 to the second posture. In other words, the sensor 43 detects reaching of the leading end of the sheet 9 to the predetermined position in downstream side from the timing rollers 32 and 34. This sensor 43 is formed from a light sensor which includes a light projecting section and a light receiving section facing each other, for instance.

As illustrated in figures such as FIG. 2 and FIG. 5, a light shielding member 39 retreats between the light projecting section and the light receiving section of the sensor 43 in accordance with the posture change of the gate member 35a is provided on a rear side (downstream side in the carrying) of the gate member 35a. The light shielding member 39 integrally rotates around the rotation shaft 31 with the gate member 35a, and retreats between the light projecting section and the light receiving section of the sensor 43. Due to the retreating operation, the light shielding member 39 leads or shields the light emitted from the light projecting section of the sensor 43 to the light receiving section in accordance with the posture change of the gate member 35. The sensor 43 detects a light receiving condition or a light shielding condition in accordance with the position of the light shielding member 39 so that it may detect the posture of the gate member 35.

The gate member 35 may be in the first posture, for instance. In this case, the light shielding member 39 has not entered between the light projecting section and the light receiving section of the sensor 43. The sensor 43 then detects the light receiving condition. On the other hand, once the sheet 9 proceeds to the predetermined position in downstream side of the timing rollers 32 and 34 and the gate member 35 changes its posture to the second posture, the light shielding member 39 has entered between the light projecting section and the light receiving section of the sensor 43. The sensor 43 is put into the light shielding condition from the light receiving condition so that it is enabled to detect that the sheet 9 has reached the predetermined position in downstream side of the timing rollers 32 and 34.

The controller 7 is enabled to detect that the leading end 9a of the sheet 9 has reached the predetermined position in downstream side of the pair of the timing rollers 32 and 34 based on an output from the sensor 43. The controller 7 temporarily stops the carrying operation of the sheet 9 in response to the detection. The controller 7 then drives again the timing roller 32 responding to the timing that the toner image formed by the image forming unit 3 moves to the position of the secondary transfer roller 25, and carries the sheet 9 toward the secondary transfer roller 25.

As described above in the present preferred embodiment, the gate member 35 including the skew correction function of the sheet 9 and the timing rollers 32 and 34 are integrally provided with the resisting unit 15. The sensor 43 is arranged to detect the leading end of the sheet 9 passing through the nip part 15a of the timing rollers 32 and 34 and reaching the predetermined position in downstream side of the timing rollers 32 and 34. Especially in the present preferred embodiment, the sensor 43 is arranged at upper position of the gate member 35 so that the three members, the gate member 35, the timing rollers 32 and 34 and the sensor 43 are compactly arranged.

The controller 7 of the present preferred embodiment drives the timing rollers 32 and 34 before the leading end of the sheet 9 fed by the feeder 11 reaches the resisting unit 15. To be more specific, the controller 7 starts driving the timing rollers 32 and 34 before the leading end of the sheet 9 reaches the resisting unit 15 so that the sheet 9 the skew of which is corrected is sent out to downstream side of the pair of timing rollers 32 and 34. The controller 7 enables the sensor 43 to detect the posture change of the gate member 35. The detail of the control by the controller 7 is explained next.

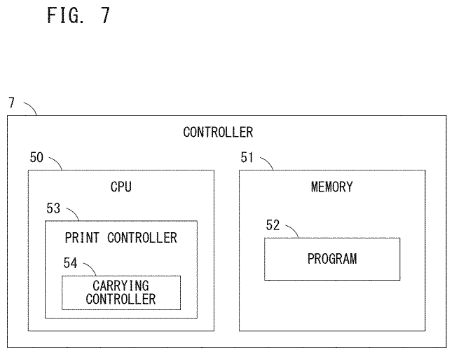

FIG. 7 illustrates a block diagram showing an example of a hardware structure and a functional structure of the controller 7. As a hardware structure, the controller 7 includes a CPU 50 and a memory 51. The CPU 50 is an arithmetic processor that executes a variety of programs. The memory 51 is a non-volatility storage device that stores therein a program 52. Once the image forming device 1 is powered, the CPU 50 reads and executes the program 52 stored in advance in the memory 51. The CPU 50 then serves as a print controller 53.

The print controller 53 controls printing based on a print job upon receiving the print job via the communication interface which is not illustrated in figures, for example. Upon starting processing of the print job, the print controller 53 drives the feeding unit 2, the image forming unit 3 and the fixing unit 4 to control to enable the image forming on the sheet 9. The print controller 53 includes a carrying controller 54. The carrying controller 54 drives rollers of the respective parts included in the feeding unit 2 to control carrying the sheet 9. The carrying controller 54, especially, enables to perform a resisting controlling process to drive the resisting unit 15 at the different timing from conventional timing. To be more specific, the carrying controller 54 starts driving the timing rollers 32 and 34 before the leading end of the sheet 9 fed by the feeder 11 reaches the resisting unit 15. The carrying controller 54, for example, determines a timing to start driving the timing rollers 32 and 34 based on the start of driving the feeder 11, then starts driving the timing rollers 32 and 34 based on the determined starting timing.

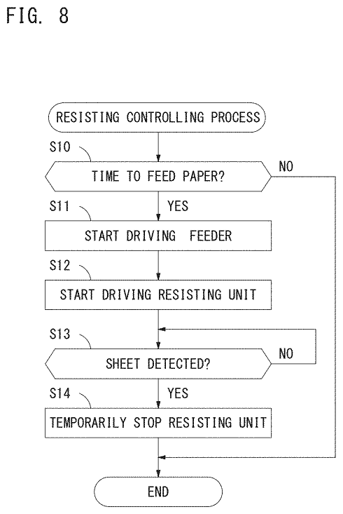

FIG. 8 illustrates a flow diagram explaining an exemplary procedure of the resisting controlling process. In this resisting controlling process of FIG. 8, the timing rollers 32 and 34 start driving at the same time as the start of driving the feeder 11. Upon start of the resisting controlling process, the carrying controller 54 determines if it is the time to feed a paper (step S10). When it is the time to feed the paper (when a result of step S10 is YES), the carrying controller 54 drives the pick-up roller 10 and starts driving the paper feeding rollers 11a and 11b of the feeder 11 (step S11). The carrying controller 54 also starts driving the timing rollers 32 and 34 of the resisting unit 15 (step S12). As a result, the timing roller 32 of the resisting unit 15 may have been rotated in the R direction at the same time as the start of the feeding operation at the feeder 11. Hence, at the time that the leading end of the sheet 9 reaches the resisting unit 15 and pushes the sheet locking unit 36 of the gate member 35 toward downstream side, the nip part 15a between the timing rollers 32 and 34 is enabled to hold the leading end of the sheet 9 and carry toward further downstream side.

When starting driving the resisting unit 15 at the same time as the start of the feeding operation, the carrying controller 54 waits until the sensor 43 detects the change in posture of the gate member 35 to the second posture (step S13). To be more specific, the carrying controller 54 waits until it is detected that the leading end of the sheet 9 reaches the predetermined position in downstream side of the timing rollers 32 and 34. When it is detected that the leading end of the sheet 9 is reached the predetermined position, the carrying controller 54 temporarily stops the carrying operation of the sheet 9 (step S14). To be more specific, the carrying controller 54 temporarily stops driving the feeder 11 and the resisting unit 15 so that it may stop carrying the sheet 9. As described above, the resisting controlling process completes.

The carrying controller 54 drives again the feeder 11 and the resisting unit 15 based on the timing that the toner image formed by the image forming unit 3 moves to the position of the secondary transfer roller 25 so that it may control that the toner image is transferred to the appropriate position on the surface of the sheet 9.

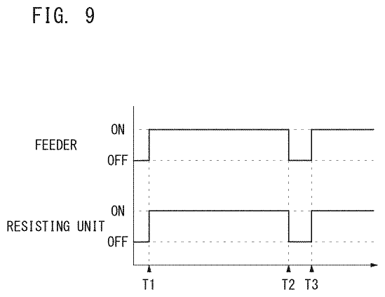

FIG. 9 illustrates an exemplary timing of driving the feeder 11 and the resisting unit 15 due to the resisting controlling process of FIG. 8. The print job is started to process and the first sheet 9 is fed at a feeding timing T1 as illustrated in FIG. 9. At the timing T1, the feeder 11 and the resisting unit 15 are driven at the same time. When it is detected that the leading end of the first sheet 9 reaches the predetermined position in downstream side of the timing rollers 32 and 34 at a timing T2, the driving of the feeder 11 and the resisting unit 15 is temporarily stopped. At a redriving timing T3 to feed out the sheet 9 to the position of the secondary transfer roller 25, the feeder 11 and the resisting unit 15 are redriven at the same time.

When the print job is to continuously prints on the multiple sheets 9, the carrying controller 54 carries the second sheet 9 or later following the first sheet 9. In this case, the carrying controller 54 may perform the resisting controlling process the same as the one of FIG. 8 for the second sheet 9 or later. When the rear end of the first sheet 9 passes through the gate member 35, for instance, the gate member 35 changes its posture to the first posture from the second posture. The light shielding member 39 then retracts between the light projecting section and the light receiving section of the sensor 43. The carrying controller 54 detects that the rear end of the first sheet 9 passes through the gate member 35 based on an output signal from the sensor 43. At the timing of the detection, the carrying controller 54 temporarily stops driving the timing rollers 32 and 34. If it is the timing to feed the second sheet 9 or later, the carrying controller 54 drives the resisting unit 15 at the same time as the feeder 11. Thus, the timing rollers 32 and 34 have already been driven by the time that the leading end of the second sheet 9 or later reaches the resisting unit 15. The leading end of the second sheet 9 or later may be led toward downstream side of the timing rollers 32 and 34. The same process is performed for the third sheet 9 or later.

The resisting controlling process different from that explained in FIG. 8 may be performed for the second sheet 9 or later. Even when detecting that the rear end of the first sheet 9 passes through the gate member 35, the carrying controller 54, for example, continuously drives the timing rollers 32 and 34 without stopping them. In this case, the timing rollers 32 and 34 have already been driving at the timing of feeding the second sheet 9. The carrying controller 54, therefore, only performs the process to start driving the feeder 11 at the timing of feeding the second sheet 9. As a result, the feeding of the second sheet 9 is started, and the timing rollers 32 and 34 have already started driving at the time that the leading end of the second sheet 9 reaches the resisting unit 15. The leading end of the second sheet 9 is then enabled to be led toward downstream side of the timing rollers 32 and 34. The same process is performed for the third sheet 9 or later. The resisting controlling process as described above is effective when the interval between the previous sheet and the following sheet is shorter than a predetermined interval, for example.

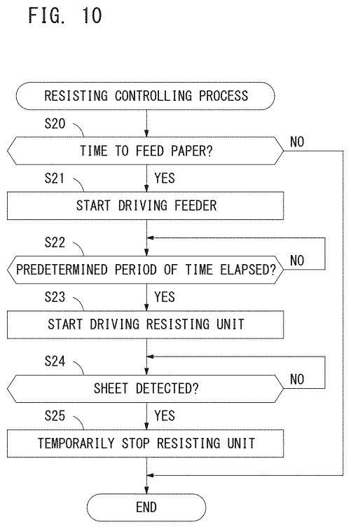

FIG. 10 illustrates a flow diagram explaining an exemplary procedure of the resisting controlling process different from that of FIG. 8. In the resisting controlling process of FIG. 10, the timing rollers 32 and 34 start driving after elapse of a predetermined time from the start of driving the feeder 11. Upon start of the resisting controlling process, the carrying controller 54 determines if it is the time to feed a paper (step S20). When it is the time to feed the paper (when a result of step S20 is YES), the carrying controller 54 drives the pick-up roller 10 and starts driving the paper feeding rollers 11a and 11b of the feeder 11 (step S21). The feeding of the sheet 9 is thus started.

The carrying controller 54 then waits until the predetermined period of time elapses from the start of driving the feeder 11 (step S22). The predetermined period of time is a time required for the leading end of the sheet 9 fed by the feeder 11 to reach the predetermined position in upstream side of the resisting unit 15. The predetermined period of time is set in advance. Upon detecting the elapse of the predetermined period of time from the start of driving the feeder 11, the carrying controller 54 starts driving the timing rollers 32 and 34 of the resisting unit 15 at the detection (step S23). The timing roller 32 is then enabled to rotate in the R direction before the leading end of the sheet 9 reaches the resisting unit 15. As a result, when the leading end of the sheet 9 reaches the resisting unit 15 and pushes the sheet locking unit 36 of the gate member 35 toward downstream side, the nip part 15a between the timing rollers 32 and 34 is enabled to hold the leading end of the sheet 9 and carry the sheet 9 toward further downstream side.

Upon starting driving the resisting unit 15, the carrying controller 54 waits until the leading end of the sheet 9 reaches the predetermined position in downstream side of the timing rollers 32 and 34 (step S24). Once the leading end of the sheet 9 reaches the predetermined position (when a result of step S24 is YES), the carrying controller 54 temporarily stops the carrying operation of the sheet 9 (step S25). The resisting controlling process is complete as described above. The process for the carrying controller 54 to redrive the feeder 11 and the resisting unit 15 is the same as that described above.

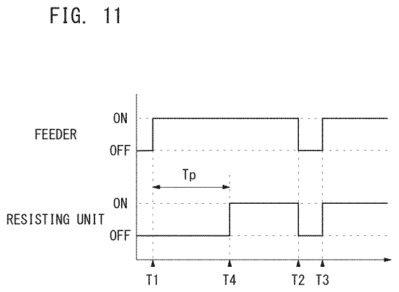

FIG. 11 illustrates an exemplary timing of driving the feeder 11 and the resisting unit 15 due to the resisting controlling process of FIG. 10. The print job is started to process and the first sheet 9 is fed at the feeding timing T1 as illustrated in FIG. 11. At the timing T1, only the feeder 11 starts driving to start feeding the sheet 9. The resisting unit 15 starts driving at a timing T4 which is after elapse of a predetermined period of time Tp from the feeding timing T1. To be more specific, the resisting unit 15 starts driving before the leading end of the first sheet 9 reaches the resisting unit 15. When it is detected that the leading end of the first sheet 9 reaches the predetermined position in downstream side of the timing rollers 32 and 34 at the timing T2, the feeder 11 and the resisting unit 15 temporarily stops driving. At the redriving timing T3 to send out the sheet 9 to the position of the secondary transfer roller 25, the feeder 11 and the resisting unit 15 are redriven at the same time. The resisting controlling process explained in FIG. 10 only enables the resisting unit 15 to drive for a shorter time compared to the resisting controlling process of FIG. 8 so that consumption of electricity may be controlled.

When the print job is to continuously prints on the multiple sheets 9, the carrying controller 54 may perform the resisting controlling process the same as the one of FIG. 10 for the second sheet 9 or later or the resisting controlling process different from the one of FIG. 10. This is the same as the control explained above so the detailed explain is skipped.

As described above, the image forming device 1 of the present preferred embodiment includes the feeder 11, the resisting unit 15, the sensor 43 and the controller 7. The feeder 11 feeds the sheet 9 and the resisting unit 15 corrects the skew of the sheet 9 fed by the feeder 11 and feeds out toward downstream side. The sensor 43 detects the sheet 9 which is fed out toward downstream side by the resisting unit 15 after the skew of the sheet 9 is corrected. The controller 7 drives the feeder 11 and the resisting unit 15, respectively. The controller 7 starts driving the resisting unit 15 before the sheet 9 fed by the feeder 11 reaches the resisting unit 15. Hence, the resisting unit 15 has already started driving when the sheet 9 reaches the resisting unit 15 so that the sheet 9 is enabled to be fed toward downstream side of the resisting unit 15 due to the carrying force of the resisting unit 15. As a result, the sensor 43 is enabled to detect that the leading end of the sheet 9 is carried to the predetermined position in downstream side of the resisting unit 15.

The controller 7 stops driving the resisting unit 15 as a result of the detection by the sensor 43 that the leading end of the sheet 9 is carried to the predetermined position in downstream side of the resisting unit 15. The controller 7, therefore, is enabled to wait until it gets the redriving timing with holding the leading end of the sheet 9 at the predetermined position in downstream side of the resisting unit 15.

As described above, a structure to enable the detector to detect the sheet carried toward downstream side by the resisting part is applied. This present invention with the structure starts driving the resisting part before the sheet fed by the feeder reaches the resisting part so that the sheet may be fed out toward downstream side from the resisting part. The detector also is enabled to detect normally the reaching of the sheet.

Although the embodiment of the present invention has been described and illustrated in detail, it is clearly understood that the same is by way of illustration and example only and not limitation, the scope of the present invention should be interpreted by terms of the appended claims.

### Modifications

While the preferred embodiment of the present invention has been described above, the present invention is not limited to the preferred embodiment. Various modifications may be applied to the present invention.

In the above-described preferred embodiment, for example, the image forming device 1 is constructed by a printer that only includes a printer function. However, this is given not for limitation. The image forming device 1 does not always have to be the printer that only includes the printer function. The image forming device 1, for example, may be constructed by a device such as one of MFPs (Multifunction Peripherals) or a facsimile device. The image forming device 1 of the present preferred embodiment is capable of producing color outputs. The image forming device 1 may be a device only capable of producing black and white outputs.

The sensor 43 of the present preferred embodiment is formed from a light sensor including the light projecting section and the light receiving section. The sensor 43 that detects posture of the gate member 35 does not always have to be the light sensor.

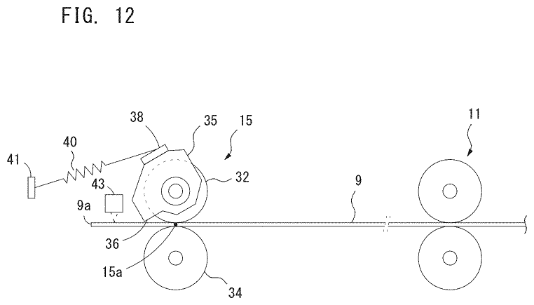

The sensor 43 of the above-described present preferred embodiment detects that posture of the gate member 35 has changed to the second posture so that it is enabled to detect that the leading end of the sheet 9 reaches the predetermined position in downstream side of the resisting unit 15. How the sensor 43 is arranged is not always have to be that explained in the above-described present preferred embodiment. The sensor 43 may be arranged to directly detect the sheet 9 carried along the carrying path in downstream side from the resisting unit 15 as illustrated in FIG. 12, for example.

The program 52 of the above-described preferred embodiment executed by the CPU 50 of the controller 7 is stored in advance in the memory 51. The program 52 may be installed in the image forming device 1 via the communication interface, for example. In this case, the program 52 may be provided over an internet in a manner that enables a user to download, or may be provided in a manner that is recorded on a computer readable recording medium such as a CD-ROM or a USB memory.

What is claimed is:

1. An image forming device comprising:
a feeder that feeds a sheet;
a resisting unit that corrects skew of the sheet fed by the feeder and carries the sheet toward downstream side;
a detector that detects the sheet carried toward downstream side by the resisting unit after the skew of the sheet is corrected; and
a hardware processor that drives the feeder and the resisting unit, respectively, wherein
the hardware processor starts driving the resisting unit before the sheet fed by the feeder reaches the resisting unit.

2. The image forming device according to claim 1, wherein the hardware processor further:
starts driving the resisting unit based on the start of driving the feeder.

3. The image forming device according to claim 1, wherein the hardware processor further:
starts driving the resisting unit at the same time as the start of driving the feeder.

4. The image forming device according to claim 1, wherein the hardware processor further:
starts driving the resisting unit after an elapse of a predetermined period of time from the start of driving the feeder.

5. The image forming device according to claim 1, wherein the hardware processor further:
stops driving the resisting unit as a result of the detection of the sheet by the detector.

6. The image forming device according to claim 1, wherein
the resisting unit includes a pair of timing rollers that hold the sheet the skew of which is corrected and carry the sheet toward downstream side.

7. The image forming device according to claim 6, wherein
the resisting unit further includes a gate member that corrects the skew of the sheet.

8. The image forming device according to claim 7, wherein
the gate member includes a sheet locking unit that locks a leading end of the sheet fed by the feeder, and
the gate member is enabled to change its posture between:
a first posture that enables the sheet locking unit to lock the sheet in upstream side of a nip part between the pair of timing rollers, and
a second posture that enables the sheet locking unit to retract to downstream side of the nip part to allow the sheet to pass through.

9. The image forming device according to claim 8, wherein
the multiple gate members are arranged along a direction orthogonal to a sheet carrying direction, and
the leading end of the sheet is in equally contact with the sheet locking units of the multiple gate members, respectively, so that the multiple gate members change the postures to the second posture from the first posture.

10. The image forming device according to claim 8, wherein
the detector detects the change in the posture of the gate member from the first posture to the second posture.

11. The image forming device according to claim 1, wherein
the detector detects that the leading end of the sheet reaches a predetermined position in downstream side of the resisting unit.

12. A controlling method applied at an image forming device comprising:
a feeder that feeds a sheet;
a resisting unit that corrects skew of the sheet fed by the feeder and carries the sheet toward downstream side; and
a detector that detects the sheet carried toward downstream side by the resisting unit after the skew of the sheet is corrected, wherein
the method comprising:
driving the feeder and starting feeding the sheet; and
starting driving the resisting unit before the sheet fed out by the feeder reaching the resisting unit.

13. The controlling method according to claim 12, wherein
the resisting unit is started driving based on the start of driving the feeder.

14. The controlling method according to claim 12, wherein
the resisting unit is started driving at the same time as the start of driving the feeder.

15. The controlling method according to claim 12, wherein
the resisting unit is started driving after an elapse of a predetermined period of time from the start of driving the feeder.

16. The controlling method according to claim 12, wherein the method further:
stopping driving the resisting unit as a result of the detection of the sheet by the detector after the resisting unit is started driving.

17. A non-transitory recording medium storing a computer readable program to be executed by a hardware processor in an image forming device comprising:
a feeder that feeds a sheet;
a resisting unit that corrects skew of the sheet fed by the feeder and carries the sheet toward downstream side; and
a detector that detects the sheet carried toward downstream side by the resisting unit after the skew of the sheet is corrected,
the hardware processor executing the computer readable program to perform:
driving the feeder and starting feeding the sheet; and
starting driving the resisting unit before the sheet fed out by the feeder reaching the resisting unit.

18. The non-transitory recording medium according to claim 17, wherein
the resisting unit is started driving based on the start of driving the feeder.

19. The non-transitory recording medium according to claim 17, wherein
the resisting unit is started driving at the same time as the start of driving the feeder.

20. The non-transitory recording medium according to claim 17, wherein
the resisting unit is started driving after an elapse of a predetermined period of time from the start of driving the feeder.

21. The non-transitory recording medium according to claim 17, wherein the hardware processor executing the computer readable program to further perform:
stopping driving the resisting unit as a result of the detection of the sheet by the detector after the resisting unit is started driving.
